(19) United States
(12) Patent Application Publication
(10) Pub. No.: US 2026/0253050 A1
(43) Pub. Date: Aug. 27, 2026

(54) Transactional Framework for Resource Location, Management and Sharing

(71) Applicant: Nicky, LLC., Casper, WY (US)

(72) Inventors: Matheus Costa Leite, Casper, WY (US); Stevan Lieberman, Silver Spring, MD (US); Michael Riedl, Luxembourg (LU); Christian Tecar, BaiaMare (RO); Kevin Kopas, Wichita Falls, TX (US); Sebastian Guerrero, Brussels (BE); Lars Jensen, Luxembourg (LU); Eshan H. Pancholi, Mumbai (IN); João Alfredo Pinto de Magalhães, Rio de Janeiro (BR); Michiel René Post, Delft (NL)

(73) Assignee: Nicky, LLC., Casper, WY (US)

(21) Appl. No.: 19/159,372

(22) PCT Filed: Feb. 23, 2024
(86) PCT No.: PCT/US2024/017145

§ 371 Date: Aug. 25, 2025

Related U.S. Application Data
(60) Provisional application No. 63/486,591, filed on Feb. 23, 2023.

(51) Int. Cl. G06Q 20/08; G06Q 20/40

(52) U.S. Cl. CPC G06Q 20/0855; G06Q 20/4014

(57) ABSTRACT

The present invention is a computerized system model allowing users to publicize, share, and transact various resources with third parties. The resources are located in external remote servers and systems and are not under the custody of the system. In the system, users may assign unique identifiers belonging to them (e.g. email addresses, social security, social media handles, and phone numbers) to facilitate being found by third parties. The invention provides standardized mechanisms for locating users, data querying and retrieval, access authorization, transaction performing, event notification, etc. The result is a robust framework with a wide range of practical applications. The document also describes a reference implementation of a conceptual model, which handles payments and transactions involving crypto-assets like Bitcoin.

### CONTINUITY

This application is a PCT non-provisional application of provisional patent application No. 63/486,591, filed on Feb. 23, 2023, and priority is claimed thereto.

### FIELD OF THE PRESENT INVENTION

The present invention relates to the field of resource management, and more specifically relates to a novel, automated and scalable system by which resources may be located, managed, transferred, and shared without necessitating the use of cumbersome digital wallet addresses, account numbers, and similar pertinent data between relevant parties.

### BACKGROUND OF THE PRESENT INVENTION

In the modern world, individuals and companies must manage vast digital data about their businesses and private lives. Documents such as invoices, contracts, medical records, educational certificates, background checks, and information such as bank account details, phone numbers, mailing addresses, calendars, ; // and crypto wallet addresses, only to name a few.

Typically, such objects are spread in different locations, such as personal computer files and service providers of widely different natures. While the popularization of cloud storage has made most of this data accessible online, it has created problems of its own: management is inherently complex and cumbersome, raising concerns about efficiency and security.

Then, there's the additional problem of which particular objects, although private and/or sensitive in nature, are often meant to be shared. A bank account number is a typical example: it's intrinsic to an individual or company, but third parties must have access to someone's account details to initiate a bank transfer.

If Alice just needs Bob's bank account details, Bob could send them to Alice in a multitude of ways, such as email, a phone call, or instant messaging. However, this interaction requires Bob's active participation, which is a scenario less than ideal:
It's a tedious, error-prone manual process;
Bob's active participation doesn't scale as frequent similar interactions will consume too much of his time;
Bob may not be readily available to provide the bank account details when Alice needs it;
Bob may resort to an unsecured channel to provide the details to Alice;
Someone may attempt to impersonate Alice to obtain the information from Bob for malicious purposes;
There's no central record of why Alice requested the information from Bob, when she did it, and for what purpose;
Bob only knows when Alice has finished using his data unless Alice informs Bob.

Alice and Bob would benefit from a solution that
Is automated;
Is scalable;
Allows Alice to access the required resource from Bob, even if Bob isn't readily available;
Guarantees that the resource will be exchanged through a secure channel;
Minimizes the odds that Bob is dealing with an impersonator of Alice;
Keeps a record of Alice's request for Bob's future reference;
Notifies Bob when Alice has finished the intended use of his resource.

The present invention aims to provide a means for users to achieve the above goals.

### SUMMARY OF THE PRESENT INVENTION

Nicky Vault is a flexible framework to quickly, securely, and efficiently share and transact resources with other users and external parties. On one hand, it allows any actor to query the system to quickly locate a user by referring to their unique nicknames: the nicks. Common nick types include email addresses, phone numbers, social media handles, and Social Security numbers. On the other hand, it allows users to specify (remote) sources for various resources they control and manage granular access, granting and/or revoking access at will.

Once an actor accesses the resource, a transaction occurs, which amounts to the resource being used and processed, with the system recording the results.

At its core, Nicky Vault acts like a “router,” resolving which user is associated with a specific nick and which user-defined source contains the resource needed for a given request. Typically, an actor will contact the system by specifying a user nick and requesting access to one of their resources. The system will analyze the request and verify (a) if a source has been specified for such a resource and (b) if the requester has the proper permission to access it. If so, a transaction will follow, such as the completion of a payment using the bank account information obtained in the request.

The following brief and detailed descriptions of the drawings are provided to explain possible embodiments of the present invention but are not provided to limit the scope of the present invention as expressed herein this summary section.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 details a flow chart depicting the general process of use of a preferred embodiment of the present invention as completed by the backend programming of the system, primarily depicting how a transaction takes place on the system.

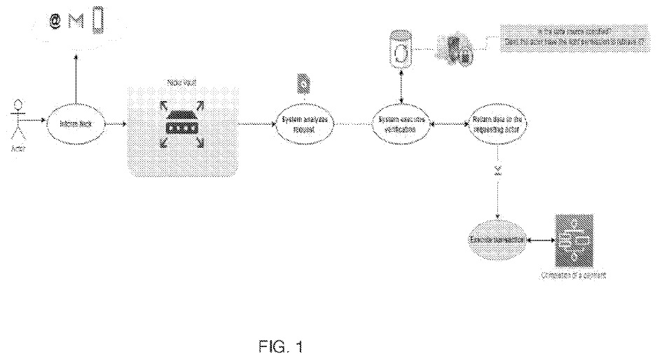

FIG. 2 exhibits a flow chart detailing an example scenario of a user named “Alice” wishing to send a user named “Bob” a crypto payment.

FIG. 3 depicts a chart detailing the user “Alice” querying the system of the present invention for a phone number nick for “Bob” for verification.

FIG. 4 shows a process by which Alice verifies the phone number between multiple potential numbers for Bob via the system and platform of the present invention.

FIG. 5 shows a process by which the user Alice verifies a UID and email address on the system and platform, and finds the authentic user Bob.

### DETAILED DESCRIPTION OF THE PREFERRED EMBODIMENTS OF THE PRESENT INVENTION

The present invention is a routing and resource permission system configured for use by users seeking to simplify resource transfers, management, and information sharing through a secure system which facilitates the setting of specific parameters, including timed access, to pertinent information pertaining to secured accounts, crypto wallets, and other digitized resources.

### The Account

The Nicky Vault system offers separate accounts where users can securely manage and configure their profiles. On the broadest level, the account model entertains two types: simple and complex. A complex account depends on at least a straightforward account, called an appointee, to be managed and has some additional features. Thus, a complex account is one where account management is shared among parties.

From simple and complex account types, it's possible to derive two subtypes that will be the focus of the present document and used in all examples and explanations: individual and organization. The former is a simple account tied to a specific person's identity, while the latter is attached to an organization such as a business, a group, a charity, etc. Therefore, it can be said that individual and organization accounts are, in reality, bound to a “soul”, be either a real person, or a real world corporate entity. In the future, simple and complex accounts representing other types of entities may be explored.

All account activity takes place in an Account Management Environment (AME). AME login access is enabled through various authentication mechanisms, explained in a later section.

Secondary aspects aside, the core configurations of one's profile in the AME are threefold:
Nicks: (creation, verification, removal, etc.);
Sources and Resources: specification of the user sources, resources, and where they are located;
Authorization: definition of access policies to various parts of the account.

Being type complex, organization accounts need one or more appointees, and every appointee has partial or complete powers to manage the organization. The organization account creator receives the master appointee title and comes with full privileges, including the exclusive right to create and revoke new (master and regular) appointees.

For example, Bob may start by setting up an individual account, and from within the tools available in the AME, there is one that allows creating an organization account for his ACME company. By doing so, Bob's account becomes the first ACME appointee: the master. He may then select other individual accounts as additional appointees, establishing appointee rights for each in the process. Some rights examples include, but are not limited to:
Whether the appointee is allowed to change the account's nicks or just view;
Whether the appointee is allowed to change the account's sources or just view;
Whether the appointee is allowed to change the account's authorization schemes or just view.

Optionally, Bob may designate a new appointee as a master, in which case all rights are automatically granted. An organization account may have an unlimited number of master and regular appointees.

From a purely systemic perspective, there are no limitations on how many organizations one may be an appointee of, though applications of the Nicky Vault framework may wish to restrict this ability in some fashion.

Organization appointees may also perform an additional action (if such right was given): manage organization members and roles. A member is another (individual or organization) account that is deemed “part” of the organization and has one or more “roles” within it. For example, an organization could have the roles of “Manager,” “Salesperson,” and “Employee,” with member Alice being a manager, Bob a salesperson, and both of them, employees.

In the previous examples, the process of designating appointees, members, and roles was simplified for clarity. In the AME, individual users may accept or deny participating as an organization appointee; personal and organization accounts may accept or deny being appointed members of some organization; however, existing members of an organization don't have a say in which roles are assigned to them—this is the realm of the appointees.

From the system's point of view, members and roles are purely symbolic, with their meanings left up to the managers. However, as it will be explained later, the introduction of roles allows the appointee to grant or deny access to the account's resources with much finer-grained control.

### The Nick

A vital component of the Nicky Vault system is the nicks. Simply put, a nick is a unique entity identifier because no two users share the same nick. Common nick types include email addresses, phone numbers, social media handles, and tax ID numbers. Advanced nick types are nontextual—for example, the digital biometric model of one's face is unique to each individual and may be used as nicks.

In our invention, each user may assign one or more nicks representing their entity, sometimes even more than one nick of the same type. However, nicks of certain types, such as the Social Security number, occur at most once per user account.

Moreover, all nicks within an account should represent the same individual or organization. Therefore, whenever it makes sense, the system will cross-check that the nicks newly assigned to an account conform and represent the same individual or organization as the existing ones in that account.

To be assigned, a nick must have its ownership verified. The verification process varies in complexity depending on the nick type. While an email nick type only requires that the user demonstrates the ability to receive a message on that address to prove ownership, a Social Security number nick type will require that the user passes a Know Your Customer (KYC) process that fully validates their identity through multiple steps. Third-party service providers typically perform KYC processes.

The mandatory verification process adds a trust layer to the system: any party interacting with Nicky Vault users will have a guarantee that the user they are interacting with has passed one or more verification processes, minimizing the odds that they are dealing with an impersonator. Furthermore, other advanced system features explained later mitigate the possibility that any interaction involving a hacked account by a malicious actor will develop.

The table below, although non-exhaustive, explains some of the nick types that Nicky Vault supports and that will be used in various examples throughout the course of the present document:

| | Entity | | Verification |
|---|---|---|---|
| Nick type | Type | What it is | Process |
| UID | Individual | A system generated | None. UIDs are |
| | Organization | numeric identifier. | assigned upon |
| | | | account creation |
| | | | and are |
| | | | immutable. |
| Privacy | Individual | A system generated | None. Privacy |
| | Organization | numeric identifier. | nicks are assigned |
| | | | upon request and |
| | | | expire after one |
| | | | transaction. |
| Ad-hoc | Individual | An email address | A link sent to |
| email | Organization | belonging to | the email address |
| | | the user. | must be opened. |
| Managed | Individual | An email address | The domain must |
| email | Organization | belonging to an | be validated by |
| | | Internet domain | including a |
| | | managed by an | special TXT |
| | | organization | record in its |
| | | account. | DNS table; the |
| | | | user must be a |
| | | | member of the |
| | | | organization or |
| | | | the organization |
| | | | itself; the |
| | | | user must be |
| | | | authorized by |
| | | | the organization; |
| | | | the user must |
| | | | pass the ad-hoc |
| | | | email verification. |
| Biometric¹ | Individual | A digital | A biometric data |
| | | representation | point collection |
| | | of the user's | procedure. |
| | | biometric data. | |
| Phone | Individual | A fully qualified | A code sent |
| number | Organization | phone number in | by SMS or |
| | | the E.164 format: | automated |
| | | [+][country][area][local | phone call |
| | | phone number] | must be |
| | | | informed to |
| | | | the system. |
| SSN | Individual | The individual's Social | The user must |
| | | Security Number (US | pass through an |
| | | persons only). | individual KYC |
| | | | process. |
| Passport | Individual | The individual's | The user must |
| | | passport number and | pass through an |
| | | issuing country (e.g. | individual KYC |
| | | [‘AA12345’, ‘Egypt’]). | process. |
| Entity | Organization | The corporate entity's | The user must |
| Registration² | | registration number. | pass through an |
| | | | corporate KYC |
| | | | process. |
| Tax ID² | Individual | The user's tax ID. | The user must |
| | Organization | | pass through |
| | | | a KYC process. |
| SSL | Individual | A cryptographically | The user must |
| Certificate | Organization | signed digital certificate | digitally sign |
| | | identifying the user. | a challenge |
| | | | file provided |
| | | | by the system. |
| External | Individual | The username at an | The user must |
| Platform | Organization | external platform and | authenticate in |
| | | the platform qualifier | their external |
| | | (e.g. [‘alice’, | account and |
| | | ‘twitter.com’]). | grant the |
| | | | relevant rights |
| | | | to the system. |

¹Biometric is an umbrella designation for various types of identifiers based on biometric data points from an individual, such as fingerprint and facial. The actual nick type depends on each instance of such identifiers. For example, the Biometric nick attached to facial recognition is ‘Biometric Facial’.
²Entity registration and Tax ID are umbrella designations for various types of identifiers whose formats and specifications are regulated by each country. The actual nick type depends on each instance of such identifiers. For example, the Tax ID in Brazil is denominated ‘CPF’ and has its own standard. The respective nick type is a ‘Brazilian CPF’.

The purpose of nicks is twofold. First, they allow for other actors to search for, and refer to, Nicky Vault users using identifiers they know and/or are accustomed with. Secondly, they add a layer of trust because each nick has been verified.

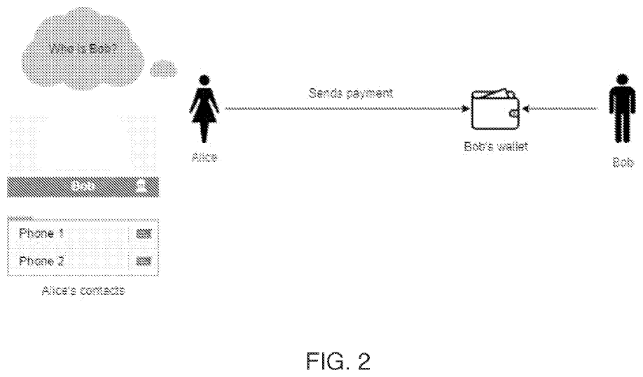

For example, suppose Alice (a second example user) wants to send Bob a crypto payment, and for that she needs Bob's Bitcoin wallet address. All Alice has is a personal notebook containing two phone numbers belonging to different individuals both called Bob, and she isn't entirely sure which number corresponds to the Bob she is after. For simplicity, assume that both phone numbers are connected to Nicky Vault accounts, i.e. they are either nicks of the same user, or of two different users. This relationship can be seen in FIG. 2.

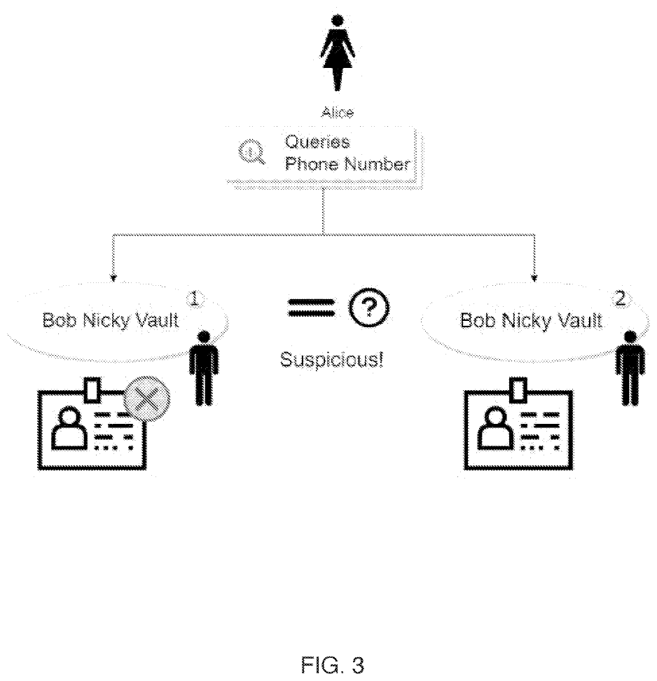

Alice initially queries the system of the present invention for the first number, and it retrieves the public profile information associated with that Bob, such as a profile picture and his UID. Alice doesn't recognize the person in the profile, and looks up the second number, which seems to be a visual match. Alice is ready to send a request to the system of the present invention for the Bitcoin wallet address associated with the second profile, but then she pauses and wonders: “What if the profile picture is of someone else resembling Bob? Or if someone registered a Nicky Account using Bob's phone and is impersonating him? I could be sending valuable bitcoins to someone else.” This conundrum can be seen in FIG. 3.

As depicted in FIG. 3, Alice queries the system of the present invention for the number Alice then learns that Bob's phone number has been verified, meaning that the individual who created the Nicky Vault account and assigned that number to a nick, actually owns that number, because verification is mandatory before a phone nick is enabled. That individual is likely Bob, as Alice recalls having had private conversations with Bob on that number. However, Alice isn't entirely convinced and wants further guarantees, because phone numbers change ownership from time to time, or are hacked. Alice knows that an impersonator gaining access to Bob's number could have created a Nicky Vault account pretending to be him.

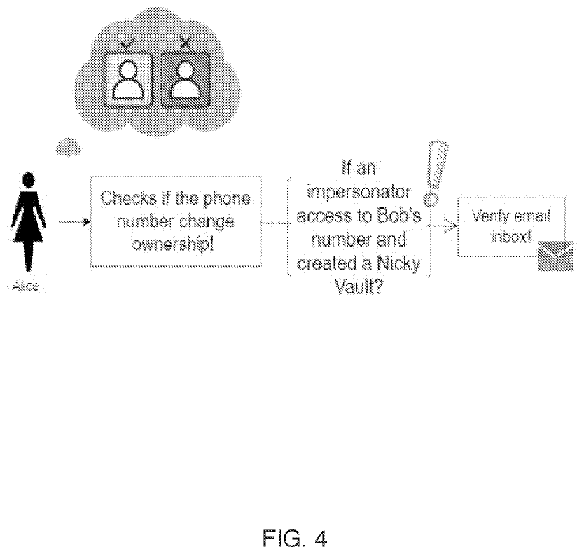

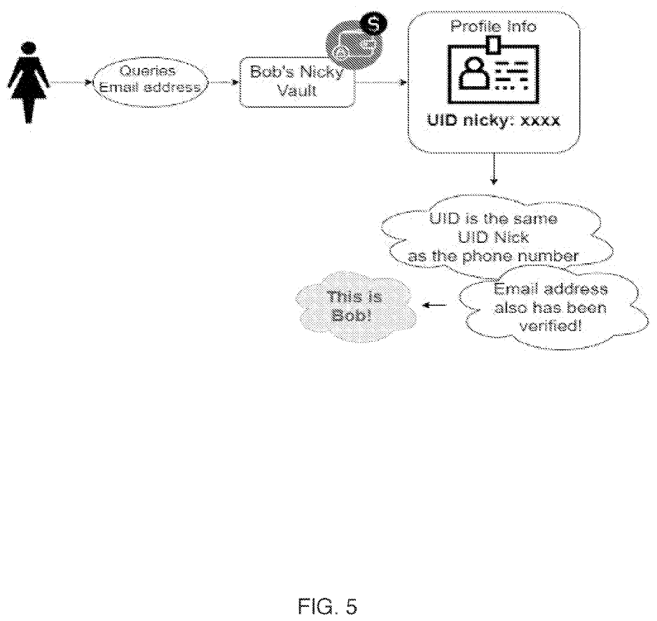

Alice checks on her email inbox for past communications with Bob, and finds his email address as depicted in FIG. 4 and FIG. 5. She queries the system of the present invention once again, this time using the newly found email address. Fortunately, Bob has also registered that address as an alternative nick, and Alice is able to query the system to verify that it is assigned to the same UID nick as the phone number. Now, Alice is more confident that she is really interacting with Bob, because that email address also has been verified, and she knows for a fact that it belongs to Bob.

Entirely comfortable that she is dealing with the faithful Bob, Alice requests the system for his Bitcoin wallet address and proceeds with the payment.

In the example shown in FIG. 5, it is clear that the present invention brings credibility to interactions, minimizing the odds that one party will interact with the wrong counterparty.

Nick registration, activation, timestamping and history

Whenever a user attempts a Nick registration in their account, the Nick goes into pending verification mode. This means the nick must still undergo a verification process before it can be used. The verification process may take minutes, as in the case of email nicks, or longer if it involves a KYC or other complex procedure. Nick's pending activations are only visible to their owners in their Nicky Vault account management area. After the verification, the nick becomes active and may be used to identify the user in the system.

At every nick event, such as (but not limited to) registration and activation, the system records a timestamp, and the timestamp information may be made available to other users and system administrators in various situations. For example, if a Nicky Vault user queries the system for public information about the nick ‘bob@acme.com’, a typical reply maybe something like:
<UID> activation:2022-12-06 15:59:30

In the line above, <UID> is a placeholder for the user's actual UID nick. The reply includes a timestamp denoting the time the email nick was activated. These two pieces of information are essential because:
The UID is immutable. Two different queries pointing to the same UID mean the two nicks belong to the same account.
The timestamp is an indicative element of a nick's maturity and may be used for auditing purposes in conjunction with other data.

The collection of timestamps allows the system to build a history for every nick. The nick history data may be used for auditing and is only available to the owners (partially) and system administrators (in full). If Bob queries the system for the history of his own nick, ‘bob@acme.com’:
<UID>registration:2022-12-06 15:56:51
<UID>activation:2022-12-06 15:59:30

Here, the system returns a list of two relevant events, namely, when Bob registered and activated the nick, with the respective timestamps of each event.

Finally, a system administrator querying for a nick history would get an even wider picture, as it would also include past accounts the nick could have been associated with. In the response below, <UID1> represents the UID of a previous account that had the ‘bob@acme.com’ nick, and <UID2> is the current account where it is active:
<UID 1> registration:2021-02-02 12:26:00
<UID 1> activation:2021-02-02 12:28:31
<UID 1> cancellation:2022-12-06 01:14:10
<UID 2> registration:2022-12-06 15:56:51
<UID 2> activation:2022-12-06 15:59:30

### Nick Collision, Expiration, Pausing, Cancellation, and Invalidation

Although all nick types must conform to a verification process that proves user control or ownership of the underlying object, it could be that a nick changes ownership over time. That is the case of phone numbers and, less commonly, email addresses, for example. That is certainly not the case for UIDs and SSNs deemed immutable. The table below summarizes the nick immutability statuses for some of the nick types discussed in this document:

| Nick type | Immutable |
|---|---|
| UID | Yes |
| Ad-hoc email | No |
| Managed email | No |
| Phone number | No |
| SSN | Yes |
| Passport | No |
| External Platform | No |

Therefore, if Alice attempts to register a nick that already belongs to Bob, two situations can develop: either the nick is of an immutable type and the request is denied, or the nick is mutable and Alice's registration attempt triggers a collision.

A collision happens when two distinct users claim ownership of the same nick. Assuming that the new user has also passed through the nick verification process, a collision resolution process ensues, which is dependent on the nick type.

Some nick types are such that the underlying identifier is subject to expiration. The expiration is a feature: it determines when the identifier's validity will cease, and is a known attribute to that identifier.

| Nick type | Expirable |
|---|---|
| UID | No |
| Ad-hoc email | No |
| Managed email | No |
| Phone number | No |
| SSN | No |
| Passport | Yes |
| External Platform | No |

In the table above, which shows some types of nicks, the passport is the only expirable type, with the expiration date bound in the underlying government-issued passport document.

In the event of expiration, the nick automatically ceases to function. The system of the present invention will send various reminders prior to expiration, suggesting that the user adds a new nick.

Furthermore, any user may request to pause one of their nicks. It means the nick will temporarily stop functioning and be put on hold, until the user resumes its operation with an “unpausing” request.

A nick cancellation will remove the nick from the user's account. It may be requested by the user, or be the result of a conflict resolution process where the user was the losing party, in which case the nick will be canceled and subsequently re-registered under the winning party's account.

Nick Vault's system administrators always trigger a nick invalidation which occurs in exceptional circumstances. It has the same practical effect as a cancellation.

### Ad-Hoc and Managed Email Nicks

Email nicks are one of the most common nick types, as email is universally known and used for communication between parties. The system of the present invention makes a distinction between two types of email nicks: “ad-hoc” and “managed.” Managed email nicks are those belonging to an Internet domain which has been validated for this very purpose. Conversely, ad-hoc email nicks are those that the respective domains have not been registered within the system.

Managed emails are meant to be used by individuals and organizations, but organizations always play a role in how they function, because only them can associate domains to their account profiles. In other words, Internet domain names are attributes of organization accounts of the system of the present invention, and not of individual accounts. However, once a domain is validated, the organization may authorize any of its members to register managed email nicks associated with the organization's domain.

For example, Bob, while logged in to COMPANY A Corporation's account as an appointee, may register the domain CompanyA.com. In the sequence, the system expects the domain to be validated, requiring that a special TXT record be included in its DNS table. Once the system verifies that this step was concluded, CompanyA.com is ready to start serving managed email nicks.

The next step is the proper managed email nick creation, which may be initiated either by COMPANY A, or by an COMPANY A member. In the first option, COMPANY A creates a nick; for example, bob@CompanyA.com, which will be used by Bob in his individual account, and assigns it to Bob by referring to his UID. Once Bob is back into his own account, he needs to approve the new nick, and lastly, verify it by clicking a link contained in a message the system will send to the email address.

In the second option, it's Bob, as a member of COMPANY A, who initiates the nick creation request. He specifies the desired nick and COMPANY A will be notified of the request. As an COMPANY A appointee, Bob then logs into COMPANY A's account, and immediately approves the request. Lastly, Bob returns to his individual account and verifies the email address just as before.

If the Company A. com domain hadn't been registered by any Nicky Vault organization in their profile, email addresses belonging to CompanyA.com could be used in an ad-hoc fashion. In this mode, Bob would just need to login to his individual account, register the email bob@CompanyA.com and perform the email link verification. No other steps are needed.

The added complexity of managed email nicks serve a security purpose: actors interacting with a user having a managed email nick have an assurance that the domain administrator expressly authorized that user to use the organization's email address within Nicky. Given that domain names are intimately tied to real world corporations and access to the DNS administration of corporate domains is tightly controlled, it's a fair assumption to make (security breaches aside) that whoever controls the domain's DNS records, represents and speaks for the real world corporation. Therefore, if Alice trusts COMPANY A (a real world corporation), she will trust the Company A. com domain administrator, and therefore will trust Bob's Nicky Vault account as legitimate, because she knows that the nick bob@CompanyA.com was approved by COMPANY A.

This is not to say that, had Bob configured bob@CompanyA.com as an ad-hoc email nick, Alice couldn't trust Bob. In both cases, the email has to go through a verification process, meaning Bob has to have access to messages sent to bob@CompanyA.com. However, with ad-hoc emails it is not possible to know whether COMPANY A would have approved of Bob's intent of using his corporate email address within Nicky Vault.

Finally, should a domain be registered by an organization for use within the system while ad-hoc email nicks belonging to that domain already exist, then such emails will be temporarily put on hold (cease functioning) and a migration process—from ad-hoc to managed—will take place. The System of the present invention does not allow ad-hoc emails to function if the respective domain name is managed by some organization. The migration process simply requires that the organization, by means of its appointee, approve the existing ad-hoc emails, which will then become managed email nicks and resume normal operation.

### Sources and Resources

In the Nicky Vault terminology, a resource is any user-owned or user-controlled object representing certain user-related information or having some function that is needed by other parties. A resource could be a digital document such as a photograph or an audio file, bank account details, a network printer or a representation of a real-world object such as a door with intelligent access control, for example.

Resources are contained by sources, which are remote servers capable of providing and controlling access to the underlying resources, whenever needed by the system. For example, if a cloud storage service hosts Alice's tax record files, the cloud service's server is the source, whereas the files are the resources.

The system allows its users to associate sources and resources to their account profiles. The two tables below illustrate in simple terms what kind of information the system would register for the sources and resources belonging to user Bob:

| Source | Source | | Source | |
|---|---|---|---|---|
| ID | Name | Source Type | Address | Source Notes |
| 1 | CoinKing | Crypto Exchange | coinking.com | Main account |
| 2 | CoinSheik | Crypto Exchange | coinsheik.com | Another |
| | | | | exchange |
| 3 | Filemaster | Cloud Service | filemaster.com | University |
| | | | | archives |
| 4 | Superprint | Print Server | superprint.com | Workgroup |
| | | | | printers |

| Resource | Source | | | Resource |
|---|---|---|---|---|
| ID | ID | Resource Name | Resource Type | Notes |
| 1 | 1 | Bitcoin savings | Bitcoin Wallet | Long-term |
| | | | | savings |
| 2 | 1 | Bitcoin tradings | Bitcoin Wallet | |
| 3 | 2 | Ethereum | Ethereum Wallet | |
| 4 | 4 | Gutemberg | Network Printer | |
| 5 | 4 | Shakespeare | Network Printer | |

In the example above, Bob has two Bitcoin wallets provided by the CoinKing source, one for savings and another for trading; an Ethereum wallet hosted by another source, CoinSheik; two network printers connected to the Superprint server; and a Filemaster source with no declared resources. Every source and resource has an internal ID, a descriptive name, a type, and user notes. Source IDs and names must be unique within the user's account, whereas resource names are unique only within each source they are attached to.

Source and resource types are built into the system and determine their structures and capabilities—the system uses the types to correctly handle sources and resources in each situation correctly. The system may incorporate new source and resource types, as long as new specifications are provided.

### Sessions

In the context of the system of the present invention, a “session” is an exchange of communications between a terminal and the system and that adheres to a specific protocol. The terminal is any remote software component (e.g. a browser script or a mobile application) capable of communicating with the system and representing either an authenticated user, or an external, anonymous party—a guest.

In basic terms, the terminal must send the system a “New Session” request detailing a specific user, identifiable by their nick, and other relevant data. Then, a session with its own unique identifier is created, acting like a tunnel where the parties exchange messages, until the end. All other request types require that a session be already initiated.

The terminal specifies the desired communication mode when a new session is created. In the asynchronous mode, the terminal and system send request and response messages to each other without coordination. It's a more straightforward and potentially faster mode, but prone to concurrency issues. Technically, concurrency occurs when a particular message order is needed or expected for proper functioning, but an error happens because the delivery order can't be guaranteed in the asynchronous mode. Therefore, it's up to the parties to implement a fault tolerance algorithm in a layer above the native protocol.

On the other hand, in the synchronous mode, one party—initially, the terminal—holds a baton to send a request while the other party sits waiting for it. When a request is sent, the sender will hold, pause, and resume execution after receiving a response from the other side. Depending on the type of request, the response may be as simple as an acknowledgment or contain additional information. Both terminal and system may release the baton one to the other occasionally, switching request-sending roles as needed.

The mechanism for baton releasing is that the party holding it must send a specific Release Baton request informing the release to the other party. Since the communication is synchronous, the receiving side will process the request by returning an acknowledgment response. From this point on, the new party with the baton has the prerogative of sending requests until it is released again.

At any moment, the party without the baton may request the baton holder to release it by sending a Request Baton request. This is the only type of request that can be sent by a party that currently doesn't hold the baton. The baton holder will acknowledge the request but is not obliged to comply. In any case, releasing the baton will require the holder to undergo the previously described process.

From the synchronous protocol above, it's easy to emulate alternative styles. In a one-way communication suitable for a variety of simple applications, the terminal, which holds the baton on session creation, never releases it. In the ping-pong style, each party releases the baton immediately after receiving a response. If the party with the baton doesn't want to send a request, they simply hold it until timeout and rerelease it.

For completeness, when referring to a pure two-way synchronous style, the meaning is the native algorithm without any previously agreed baton-releasing etiquette. Only in the two-way style is the request baton feature ever used, as it significantly complicates the protocol implementation.

Therefore, the communication styles supported by the system can be compiled as:
Asynchronous
Two-way synchronous
Ping-pong synchronous
One-way synchronous

Typically, the style choice will be determined by the specific software component that is communicating with the system. For example, a browser form powered by a script that is able to search for Nicky Vault users might not have the capability (or the need) to handle incoming requests. In this case, one-way communication is enough: the script sends a message, holds in wait and resumes execution when there is a response, keeping the baton and repeating the process as long as necessary.

In another scenario, a more sophisticated component such as a mobile application could be interested in receiving requests for providing certain information. For example, if Alice has a mobile application connected to a session with Bob's account, at any point could Bob demand that Alice produce a “proof of humanity” by sending a specific request to her mobile application. A “proof of humanity” involves Alice passing a certain challenge, such as making a short video of herself, in order to convince Bob that she is actually the person behind the terminal, rather than an imposter.

The types of requests that the terminal and the system may send to each other differ, with some intersection. Not all requests and responses are available in the asynchronous mode.

| Request | Sender | Parameters | Response | Description |
|---|---|---|---|---|
| New | Term | Terminal | Session | Starts a new |
| Session | | Configuration | | session, providing |
| | | | | information about |
| | | | | the terminal and |
| | | | | its actor (i.e. |
| | | | | either a guest or |
| | | | | an authenticated |
| | | | | account), and |
| | | | | other session |
| | | | | configuration |
| | | | | parameters, |
| | | | | such as the desired |
| | | | | communication |
| | | | | style. |
| | | | | The supported |
| | | | | styles are: |
| | | | | asynchronous, |
| | | | | two-way, one-way |
| | | | | and ping-pong. |
| | | | | When specifying |
| | | | | the later, the |
| | | | | terminal may |
| | | | | include a timeout |
| | | | | parameter. |
| | | | | Initially, the |
| | | | | session isn't |
| | | | | connected to any |
| | | | | system account. |
| | | | | Returns information |
| | | | | about the new |
| | | | | session. |
| | | | | Doesn't require |
| | | | | a connected |
| | | | | account. |
| Connect | Term | Nick | Ack | Connects the |
| | | | | session to the |
| | | | | account specified |
| | | | | by the nick, |
| | | | | disconnecting from |
| | | | | the current one |
| | | | | if needed. |
| | | | | A session can be |
| | | | | connected to one |
| | | | | account at a time. |
| | | | | Returns an |
| | | | | acknowledgement. |
| | | | | Doesn't require |
| | | | | a connected |
| | | | | account. |
| Disconnect | Term | | Ack | Disconnects the |
| | | | | session to the |
| | | | | connected account, |
| | | | | if any. |
| | | | | Doesn't require |
| | | | | a connected |
| | | | | account. |
| Request | Term | | Ack | Requests the baton |
| Baton | Sys | | | to the current |
| | | | | holder. There's |
| | | | | no obligation that |
| | | | | the holder will |
| | | | | release it. |
| | | | | Doesn't require |
| | | | | a connected |
| | | | | account. |
| Release | Term | | Ack | Releases the baton, |
| Baton | Sys | | | allowing the |
| | | | | other party to |
| | | | | start sending |
| | | | | requests. |
| | | | | Doesn't require |
| | | | | a connected |
| | | | | account. |
| Query | Term | | Session | Returns information |
| Session | | | | about the current |
| | | | | session. |
| | | | | Doesn't require |
| | | | | a connected |
| | | | | account. |
| Query | Term | Query | Nicks | Returns a list |
| Nicks | | | | of information |
| | | | | about the visible |
| | | | | nicks matching |
| | | | | the query. |
| | | | | Doesn't require |
| | | | | a connected |
| | | | | account. |
| Query | Term | Query | Sources | Returns a list of |
| Sources | | | | information about |
| | | | | the visible |
| | | | | sources matching |
| | | | | the query. |
| | | | | Requires a |
| | | | | connected account. |
| Query | Term | Query | Resources | Returns a list of |
| Resources | | | | information about |
| | | | | the visible |
| | | | | resources matching |
| | | | | the query. |
| | | | | Requires a |
| | | | | connected account. |
| Get | Term | Resource ID | File | Returns a full |
| Resource | | | | digital copy of |
| | | | | the specified |
| | | | | resource. This |
| | | | | method is valid |
| | | | | for informational |
| | | | | resources whose |
| | | | | digital |
| | | | | representation |
| | | | | can be copied and |
| | | | | transferred over |
| | | | | to the requester. |
| | | | | This method is |
| | | | | equivalent to |
| | | | | Use Resource with |
| | | | | a GET parameter. |
| | | | | Requires a |
| | | | | connected account. |
| Use | Term | Resource | Results | Invokes the |
| Resource | | Method | | specified method |
| | | Parameters | | of the specified |
| | | Resource ID | | resource, using |
| | | | | the specified |
| | | | | parameters. The |
| | | | | invoked method |
| | | | | results are returned |
| | | | | as response to |
| | | | | the request. |
| | | | | Requires a |
| | | | | connected account. |
| Lock | Term | Object ID | Lock | Attempts to add a |
| Resource | | | | temporary lock |
| | | | | to the specified |
| | | | | resource or source |
| | | | | object. If a lock |
| | | | | is successfully |
| | | | | placed, further |
| | | | | requests (from any |
| | | | | other terminals) |
| | | | | for accessing the |
| | | | | object will be |
| | | | | denied until the |
| | | | | lock is removed, |
| | | | | but queries are |
| | | | | still allowed. |
| | | | | Locking a source |
| | | | | locks all resources |
| | | | | beneath it. |
| | | | | Returns information |
| | | | | about the lock. |
| | | | | Requires a |
| | | | | connected account. |
| Unlock | Term | Lock | Result | Attempts to remove |
| | | | | a temporary lock |
| | | | | from the source or |
| | | | | resource associated |
| | | | | with the specified |
| | | | | lock. |
| | | | | Returns a boolean |
| | | | | representing the |
| | | | | success of the |
| | | | | operation. |
| | | | | Requires a |
| | | | | connected account. |
| Notify | Term | Subject | Ack | Sends a notification |
| (Example - | Sys | Notification | | message under the |
| Notify | | | | specified subject, |
| that a | | | | and intended to be |
| payment | | | | delivered to the |
| has been | | | | other party. |
| made.) | | | | The receiving |
| | | | | party will use |
| | | | | various parallel |
| | | | | mechanisms and |
| | | | | mediums for |
| | | | | fulfilling delivery |
| | | | | to the other party, |
| | | | | but won't wait |
| | | | | until actual |
| | | | | delivery for |
| | | | | sending an |
| | | | | acknowledgement |
| | | | | response. |
| | | | | The subject is a |
| | | | | simple text. |
| | | | | The notification |
| | | | | may be simple |
| | | | | text or another |
| | | | | complex structure. |
| | | | | Requires a |
| | | | | connected account. |
| Ask | Term | Subject | Answer | Sends a question |
| (Ask | Sys | Question | | message intended to |
| for | | | | be delivered to the |
| proof of | | | | other party, under |
| humanity) | | | | the specified |
| | | | | subject, and which |
| | | | | requires an |
| | | | | immediate text |
| | | | | answer from them. |
| | | | | The receiving |
| | | | | party will use |
| | | | | various parallel |
| | | | | mechanisms and |
| | | | | mediums for |
| | | | | fulfilling |
| | | | | delivery to |
| | | | | the other party, |
| | | | | collect and return |
| | | | | their answer. |
| | | | | The subject is |
| | | | | a simple text. |
| | | | | The question and |
| | | | | answer may be |
| | | | | simple text or |
| | | | | another complex |
| | | | | structure. |
| | | | | Requires a |
| | | | | connected account. |
| Permit | Term | Query | Objects | Requests the |
| | | | | provider to enable |
| | | | | permission for |
| | | | | accessing the |
| | | | | objects matching |
| | | | | the specified |
| | | | | query. |
| | | | | The system will |
| | | | | notify the account |
| | | | | owner using |
| | | | | various parallel |
| | | | | mechanisms and |
| | | | | mediums, and |
| | | | | prompt them to |
| | | | | take action. |
| | | | | Returns a subset |
| | | | | of the matching |
| | | | | objects to which |
| | | | | the terminal has |
| | | | | access permission |
| | | | | after the account |
| | | | | owner handled the |
| | | | | request. |
| | | | | Requires a |
| | | | | connected account. |
| End | Term | | Session | Requests the |
| Session | | | | system to terminate |
| | | | | the current |
| | | | | session. All locked |
| | | | | sources and |
| | | | | resources are |
| | | | | unlocked and the |
| | | | | session ends. |
| | | | | Returns information |
| | | | | about the ended |
| | | | | session. |
| | | | | Doesn't require |
| | | | | a connected |
| | | | | account. |
| Session | Sys | Session | Ack | Signals the terminal |
| Ended | | | | that the system has |
| | | | | unilaterally ended |
| | | | | the current session, |
| | | | | providing |
| | | | | information |
| | | | | about it. |
| | | | | Returns an |
| | | | | acknowledgement. |
| | | | | Doesn't require |
| | | | | the connected |
| | | | | account. |

### Authentication Layer

The Authentication Layer exists in order to grant access to the AME of each account. In the present document, a few authentication mechanisms are described, which may be used solely or in conjunction, in order to strengthen the account's security against unauthorized third-party access. However, the extensible nature of the system of the present invention allows new authentication methods to be incorporated later on.

As organization accounts are managed by individual accounts, the way authentication works for each account type is slightly different. In order to view or manage an organization account, the appointee must first login to their own individual Nicky Vault account of the platform and system of the present invention, and from there, use the AME toolbox to login to the organization's account. Therefore, the appointee will be simultaneously logged into two accounts: the organization's and their own.

For all of the methods described below, there is a process whose outcome may be either positive (the user is authenticated) or negative (authentication failure). An “authentication scheme” defines which methods are applied in conjunction for a certain account, and account management access is granted only if the outcome is positive in all methods participating in a given scheme. It's strongly recommended that an authentication scheme contains at least two methods.

| | Entity | | | Positive |
|---|---|---|---|---|
| Method | Type | Parameter | Description | Outcome |
| Appointee | Organization | | This | The user is |
| | | | authentication | an appointee |
| | | | method checks | of the |
| | | | that the | organization. |
| | | | user is an | |
| | | | appointee | |
| | | | of the | |
| | | | organization. | |
| | | | Organization | |
| | | | accounts | |
| | | | must have | |
| | | | this method | |
| | | | in their | |
| | | | authentication | |
| | | | schemes. | |
| Password | Individual | Nick | The user | The provided |
| | Organization | Password | provides a | password is |
| | | | nick in | correct for |
| | | | conjunction | the account. |
| | | | with a | |
| | | | previously | |
| | | | recorded | |
| | | | password. | |
| | | | The password | |
| | | | is an | |
| | | | attribute of | |
| | | | the account, | |
| | | | not of a | |
| | | | particular | |
| | | | nick. | |
| Phone | Individual | PhoneNumber | The user | The user |
| Number | Organization | Code | provides a | correctly |
| | | | phone number | provides |
| | | | nick, which | the code |
| | | | triggers the | within a |
| | | | system to | specified |
| | | | send a SMS | timeframe. |
| | | | or automated | |
| | | | phone call | |
| | | | with a code | |
| | | | to that | |
| | | | number. | |
| Magic | Individual | Email | The user | The user |
| Link | Organization | Code | provides an | opens the |
| | | | (ad-hoc or | specified |
| | | | managed) | link within |
| | | | email nick, | a given |
| | | | which | timeframe. |
| | | | triggers | |
| | | | the system | |
| | | | to send a | |
| | | | message to | |
| | | | that email | |
| | | | address | |
| | | | containing | |
| | | | a code | |
| | | | embedded | |
| | | | in a magic | |
| | | | link. | |
| External | Individual | OAuth | The user | The user |
| Platform | Organization | | logs into | is logged |
| | | | their account | in to the |
| | | | at an | external |
| | | | external | platform. |
| | | | platform, | |
| | | | such as | |
| | | | Facebook and | |
| | | | Telegram, | |
| | | | and such | |
| | | | external | |
| | | | account | |
| | | | has been | |
| | | | previously | |
| | | | registered | |
| | | | as a nick | |
| | | | to the user. | |
| Dynamic | Individual | Nick | A dynamic, | The user |
| Code | Organization | Code | time- | provides |
| | | | sensitive | the right |
| | | | code generator | time- |
| | | | such as | sensitive |
| | | | Google | code for |
| | | | Authenticator | the |
| | | | is associated | account. |
| | | | with the user's | |
| | | | account. The | |
| | | | user provides | |
| | | | any of their | |
| | | | nicks in | |
| | | | conjunction | |
| | | | with a code. | |
| Biometric | Individual | DataPoints | The system | The user |
| | | | launches a | succeeds |
| | | | biometric | in the |
| | | | challenge, | biometric |
| | | | such as | challenge |
| | | | facial | within a |
| | | | recognition, | specified |
| | | | fingerprint | maximum |
| | | | detection, | number of |
| | | | or voice | attempts. |
| | | | recognition, | |
| | | | which is | |
| | | | analyzed | |
| | | | against | |
| | | | previously | |
| | | | stored | |
| | | | biometric | |
| | | | data points. | |
| | | | The user is | |
| | | | prompted to | |
| | | | pass the | |
| | | | challenge. | |
| SSL | Individual | SignedFile | The system | The user |
| | Organization | | provides a | succeeds |
| | | | challenge | in signing |
| | | | file and | the file. |
| | | | the user is | |
| | | | prompted to | |
| | | | sign it | |
| | | | using the | |
| | | | private key | |
| | | | stored in | |
| | | | any of their | |
| | | | certificate | |
| | | | nicks. | |
| Backup | Individual | Nick | The user is | The backup |
| Code | Organization | Code | prompted to | code used |
| | | | enter a | is correct |
| | | | nick along | and has |
| | | | a one-time | never been |
| | | | use backup | used before. |
| | | | code which | |
| | | | has been | |
| | | | previously | |
| | | | generated | |
| | | | and presented | |
| | | | to them. | |
| WebAuthN | Individual | Lorem Ipsum | WebAuthN is a | A public |
| | Organization | | specification | key is |
| | | | that allows | stored on |
| | | | servers to | the server. |
| | | | register and | The browser |
| | | | authenticate | requests a |
| | | | users using | challenge |
| | | | public key | to be signed |
| | | | cryptography. | from the |
| | | | The | server. |
| | | | certificate of | The signing |
| | | | authenticity is | must be done |
| | | | cryptographically | by an |
| | | | protected by | authentication |
| | | | the public key | device |
| | | | procedure during | (pin/biometrics). |
| | | | transfer, and | The signed |
| | | | the confidential | challenge is |
| | | | data remains on | sent back to |
| | | | the user's | the server |
| | | | device. The | and is |
| | | | server can then | checked with |
| | | | use the public | the stored |
| | | | key to prove the | public key. |
| | | | user's identity. | |
| | | | WebAuthN allows | |
| | | | servers to | |
| | | | integrate with | |
| | | | strong | |
| | | | authenticators | |
| | | | built into | |
| | | | devices. | |
| Web3 | Individual | Lorem Ipsum | Web3 | The user is |
| | Organization | | Authentication | able to prove |
| | | | is a | account |
| | | | cryptographically | ownership by |
| | | | secure one-click | signing a |
| | | | authentication | string |
| | | | method which | presented |
| | | | uses a browser | by the |
| | | | extension (e.g. | system using |
| | | | MetaMask). The | the private |
| | | | extension works | key that is |
| | | | like a crypto | installed |
| | | | wallet, and the | in the |
| | | | user may send | extension. |
| | | | and receive | |
| | | | crypto tokens | |
| | | | through it. | |
| | | | The flow | |
| | | | involves the | |
| | | | system | |
| | | | generating a | |
| | | | random or semi- | |
| | | | random number | |
| | | | (nounce) | |
| | | | through the | |
| | | | system interface | |
| | | | for the user. | |
| | | | The system uses | |
| | | | the nounce to | |
| | | | verify the user's | |
| | | | signature and | |
| | | | determine that | |
| | | | the user owns | |
| | | | that address. | |

### Authentication Challenges

Authentication challenges are ancillary procedures that run along an authentication scheme and that the user must pass, with an outcome either positive or negative, but that should not be used as the sole authentication methods for one's account. These include:
Personal mnemonic questions;
“Proof of humanity” challenges (e.g. captchas);
“Proof of geolocation”.

### Trusted Friend Failover

The “Trusted Friend Failover” is a backdoor to a user's account that grants access to another user, regarded as a “trusted friend.” It works like an authentication method, although it doesn't participate in the user's own authentication scheme. The outcome is positive if these three conditions are met: the trusted friend has been previously recorded as such by the account owner; the trusted friend is fully authenticated in their own account; a specified amount of time has elapsed since the trusted friend initiated the request without the account owner opposing granting access.

Typically, the time lapse will be in the range of days or weeks, in order to give plenty of time for the account owner to block unauthorized access attempts. This authentication method is designed as a last resort method or to be used if the account owner is temporarily or permanently physically disabled.

### Authorization Layer

The system provides a series of tools to allow users to specify how they wish other users and external actors to interact with their resources. Typically, the user would find such tools available for use in the AME.

In many other systems such as operating systems and file sharing applications, access authorization policies are user centric, meaning the final decision as to whether or not to authorize access to certain data is based on an analysis of who is requesting the data.

The approach of the present invention expands on the user-centric view, allowing for the definition of complex authorization policies based on a variety of factors, such as where the requester is located, when the request is made and how the request is made-that is, taking in consideration circumstantial factors related to the request.

Let's illustrate with a few practical examples. First, a problem arises when using the System of the present invention for accessing cryptoasset addresses. In theory, the information regarding crypto wallet addresses is harmless, to the extent that they can only be used to receive incoming assets. In this case, it could be in the user's interest to keep access always open.

A second example is the problem of sharing medical records. For a correct clinical assessment, having access to a patient's full profile—including records with medicines taken, preconditions, known diseases, exams, and so on—is paramount. However, this type of information is intrinsically sensitive, and the user must be able to restrict access to certain actors, such as their personal doctor.

A third case is an account on the system and platform of the present invention representing a retail business. It could be in the business owner's interest that the sales data be available to everyone in the sales team, and denied to other parties.

These three cases may be respectively categorized in the following access levels: Public, User, and Role. While the first is an “open gates” policy, the last two are user centric, as they focus on identifying who the requester is. The system could be further configured to:
In the cryptoassets example, restrict access to requests from within the US;
In the medical records example, allow access to the patient's records only if the doctor has logged into in the system with facial recognition, thus minimizing the odds of unauthorized account access to the doctor's account;
In the retail business example, allow employees to access sales data only during business hours.

Clearly, the modified access rules are now more fine-grained and allow for greater control than a simple user centric approach.

Furthermore, the system allows for access authorization to be configured and applied beyond the context of user resources. In fact, the system allows for every piece of user account information to be controlled by the authorization layer, as it will be later evidenced.

### Access Level Methods

The table below summarizes the system's built-in access levels, though the framework may be expanded to include new levels in the future:

| Access | | |
|---|---|---|
| Level | Parameters | Authorization |
| AuthMethod | Methods | Any requester currently authenticated |
| | | with a method within the specified |
| | | list. An empty list authorizes |
| | | requesters authenticated with any |
| | | method, but not unauthenticated |
| | | requesters. |
| Calendar | Calendar | If ‘Blacklist’=FALSE: Any |
| | TimeZone | request occurring during the |
| | Blacklist | specified calendar parameter, in |
| | | the specified time zone. |
| | | If ‘Blacklist’=TRUE: Any |
| | | request occurring out of the |
| | | specified calendar parameter, in |
| | | the specified time zone. |
| | | A calendar is a complex structure |
| | | containing information of when |
| | | it is active, starting from the |
| | | years and down to the millisecond. |
| Geo | Regions | If ‘Blacklist’=FALSE: Any |
| | Blacklist | request whose connection IP has been |
| | | geolocated as being from any of the |
| | | specified regions. |
| | | If ‘Blacklist’=TRUE: Any |
| | | request whose connection |
| | | IP has been geolocated as being from |
| | | outside all of the specified regions. |
| IP | Range | If ‘Blacklist’=FALSE: Any |
| | Blacklist | request whose connection IP number |
| | | is within the specified range. |
| | | If ‘Blacklist’=TRUE: Any |
| | | request whose connection IP number |
| | | is not within the specified range. |
| KYC | Count | Any authenticated requester owning a |
| | | number of KYC-verified nicks equal |
| | | to the ‘Count’ parameter. The |
| | | minimum count is 1. |
| NickType | Types | Any authenticated requester owning |
| | | any of the specified nick types in |
| | | their account profile. |
| Protected | Code | Any request containing the specified |
| | | secret access code. |
| Role | Roles | If ‘Blacklist’=FALSE: Any |
| | Blacklist | authenticated requester having an |
| | | organization role within the |
| | | specified list. |
| | | If ‘Blacklist’=TRUE: Any |
| | | authenticated requester not having |
| | | an organization role within the |
| | | specified list. |
| | | Note: this access level is exclusive |
| | | to organization accounts and |
| | | accounts of its members. Roles are |
| | | not visible to non-member accounts. |
| Public | | Any request. |
| Time | Intervals | Any request occurring during the |
| | Zone | specified daily time intervals, in |
| | | the specified time zone. |
| User | Users | If ‘Blacklist’=TRUE: Any |
| | Blacklist | authenticated requester specified in |
| | | the user list. |
| | | If ‘Blacklist’=FALSE: Any |
| | | authenticated requester not specified |
| | | in the user list. |

### Access Levels Schemes

In order to be effectively used, access levels must be configured in the context of “access level schemes.” While the access level methods deal with the who, where, when and how, the schemes primarily solve the problem of connecting methods to what is affected by the policy—that is, what set of data, resource or account information will have its access controlled. In the context of the present document, the “what” is called an “object.”

Basically, a scheme has three components:
Expression: a list of configured access level methods connected by AND and OR operators;
Object Filters: a list of object filters matching the actual objects that will be controlled by the scheme.
Expiration modes: special modes indicating if and when the scheme expires;

Any object can have its access controlled by, at most, one scheme. An object with no schemes can only be accessed by the account owner or appointee.

In analyzing the expression scheme component, it can be seen that the use of logical expressions allows the building of complex authorization policies, as exemplified in the table below:

| Description | Expression |
|---|---|
| Anyone | Public( ) |
| Only Alice | User([‘Alice’],FALSE) |
| Alice | User([‘Alice’,‘Bob’],FALSE) |
| and Bob | |
| All system | AuthMethod( ) |
| users | |
| All system | AuthMethod( ) AND User([‘Alice’],TRUE) |
| users, | |
| except | |
| Alice | |
| Users from | Geo([‘Europe’],FALSE) OR User([‘Alice’]) |
| Europe, | |
| and Alice | |
| COMPANY A | Role([‘CompanyA.Employee’]),FALSE) AND |
| employees | Geo([‘US’],TRUE) |
| accessing | |
| from outside | |
| the US | |
| COMPANY A | (Role([‘CompanyA.Employee’]),FALSE) AND |
| employees | Geo([‘US’],FALSE)) OR User([Alice],FALSE) |
| accessing | |
| from the | |
| US, and | |
| Alice | |
| Alice, but | User([‘Alice’],FALSE) AND NickType([‘Biometric’]) |
| only if | |
| she has | |
| enrolled a | |
| Biometric | |
| nick | |
| Alice, | User([‘Alice’],FALSE) AND AuthMethod([‘Biometric’]) |
| but only | |
| if she is | |
| logged in | |
| with Biometric | |
| authentication | |

The system stipulates that the following object types can be protected by access control policies:
Sources: the sources associated with an account;
Resources: the resources associated with the sources;
Nicks: the nicks associated with an account.

The table below gives a few examples of object filters, using a simple and self-explanatory syntax. Each specification line in the “Target Filter” column matches zero or more target objects in the user's account.

| Description | Object Filter |
|---|---|
| All nicks | Type=NICK |
| All phone number | Type=NICK,NickType=PHONE |
| nicks | |
| Nick | Type=NICK,NickType=MANAGED_EMAIL,Value=’bob@Comp |
| bob@COMPANYA. | anyA.com’ |
| com | |
| All wallets at | Type=SOURCE,SourceName=’CoinKing’ |
| CoinKing | |
| All wallets at all | Type=SOURCE,SourceType=’Crypto Exchange’ |
| exchanges | |
| Bitcoin wallets | Type=RESOURCE,Resource Type=’Bitcoin’ |
| Bitcoin wallet at | Type=RESOURCE,ResourceType=’Bitcoin’,SourceName=’CoinKing’ |
| CoinKing | |
| All network printers | Type=RESOURCE,ResourceType=’Printer’ |
| Gutemberg printer | Type=RESOURCE,ResourceType=’Printer’,ResourceName=’Gutemberg’ |

Once properly set with an access level expression and object filters, the next step is to determine the scheme's expiration mode. By default, a schema never expires. However, there are two built-in expiration modes that, if present, indicate the circumstances where the schema ceases to exist:

| Expiration Mode | Parameters | Description |
|---|---|---|
| Good From/Until | Time | The schema is valid until the |
| | | specified time |
| Multiple Entry | N | The schema is valid for N |
| | | times, each time being |
| | | counted whenever a user has |
| | | access granted to an object |
| | | by virtue of this schema. |

In the event of expiration, the system will remove the schema, and force all users currently using the affected objects to re-check their permissions and undergo a new authorization process.

### Dynamic Authorization

The examples described in the previous section implicitly assume that users of the system of the present invention know beforehand which individuals or groups should have access to their resources, and thus have configured their profiles with the corresponding access levels.

However, let's consider that Bob is a manager of COMPANY A, and needs to share confidential information with some colleagues, but not all. Bob doesn't know beforehand which COMPANY A colleagues should have access granted; this assessment is done on a case by case basis as they request access to him. It's vital that Bob be able to selectively authorize or deny access upon every request from an interested colleague.

The system of the present invention has a built-in dynamic authorization feature which allows for just that. Any data requester that needs authorization to access data from a certain user may initiate an “access request” to that user. The user will be notified of the request and prompted to take action.

If the requester is not a registered user of the system of the present invention, or is not authenticated as such, the system may prompt them to (optionally) provide information to help the account owner decide. Such information, which may include basic identity data as well as the reason behind the request, are an integral part of the access request packet. Other information in the packet may include the originating IP address, operating system version, and any other environmental variables that might be captured by the system. It must be noted that the requester's provided identity information comes with a caveat, as it has not passed a verification process.

On the other hand, if the requester is authenticated in their own account, then the access request packet will include all public information on the requester's profile, plus any private profile information that they may want to include in the request. The rest of the packet is similar as in the previous example.

When COMPANY A's system account (of which Bob is an appointee) receives an access request from his colleague Alice, Bob must make a decision based on the information contained in the access request packet that is presented. In order to authorize Alice, COMPANY A could do one of the following:
Set up a Geo access level that includes Alice's current location;
Set up an IP access level whose IP range includes Alice's IP;
Set up a KYC access level (in case Alice has a KYC verified nick);
Set up a “AuthMethod” access level matching any authentication method, which will automatically include Alice as she's already authenticated in Nicky Vault herself;
Include Alice's role in a “Role” access level for the target data;
Set up Alice's individual account under User access level for the target data;
Set up a new “Protected” access for the target data, sharing the respective code with Alice.
Set up a “Public” access level for the target data.

If COMPANY A fails to do any of the above, Alice won't be part of any access level configured by Bob for the data she wanted to access; therefore, the request is effectively denied.

Finally, if COMPANY A receives a data access request from an unknown, unauthenticated actor, his authorization options will be more limited, but the Geo, IP, Protected and Public access levels would still work as they don't require authentication.

A Nicky Vault implementation for the crypto universe

In this section, the Nicky Vault for Crypto (NVC) is described, a reference implementation of the conceptual Nicky Vault model for seamlessly enabling payments using crypto-assets such as Bitcoin and Ethereum, allowing actors to send payments to NVC users by only referring to their nicks, not to their crypto addresses.

The universe of crypto payments presents an interesting case where a need for such a system is made visible: crypto addresses are known for being difficult to read, and impossible to memorize. In our system, one may reach a user by simply typing a nick such as their email address, and to further obtain the user's wallet information just by entering the type of cryptoasset. Also, a user may have multiple wallets distributed across many different sources, but the system unifies and simplifies wallet access and management by connecting all wallets to a single Nicky Vault account.

The initial version of NVC will be positioned as a business-to-consumer (B2C) solution, and will be offered in partnership with Internet domain registrars. Internet domain owners will be able to sign up for NVC as organization users, attach a domain to their accounts, and set up the domain to instantiate a managed email nick.

The concepts present in the framework can be instantiated as follows:

Accounts: all accounts will be of the “organization” type, as they will model real businesses. However, in order to ease further evolutions for the system, an individual account will be created for each organization account, which will define the one and only appointee for the organization account.

Sources and resources: as the system aims to handle crypto wallet addresses, it will be integrated with exchanges, which will be the sources for the crypto wallet addresses resources.

Nicks: emails and unique user identifiers (randomly chosen by the system) will be used as nicks for the organization accounts. Registration will be carried out as a challenge sent to the chosen e-mail, where the user must provide a random info sent in the message. All e-mails will be managed.

Authentication: will be based on usernames and passwords.

Authorization: wallet addresses will be public.

### Optimizing Transaction Costs With Nicky Vault

Following the above description of the Nicky Vault for Crypto (NVC) as a system to simplify the crypto payment process, the present invention provides an additional feature that addresses the optimization of transaction costs. This functionality within NVC aims to assist users in minimizing expenses when converting and off-ramping crypto assets to their regular fiat bank accounts.

### Real-Time Fee and Exchange Rate Comparison

Within the Nicky Vault ecosystem, a user intending to transfer an amount of cryptocurrency will have the advantage of accessing a real-time comparison of transaction fees and exchange rates across various exchanges. This feature is crucial as it allows for an informed decision-making process, ensuring that users can choose the most cost-effective and beneficial time to convert and withdraw their assets.

Such fees and conditions usually depend on different things like the given user, the current state of the market (if it is bullish or bearish), the country (because regulations might imply some extra fees, and because bank fees might vary), the currency, just to mention a few, so it is important to dynamically calculate the possible scenarios considering all these parameters in order to find the best fit for that specific occasion.

It is important to state that most exchanges offer such parameters through some well documented retrieval APIs for a given user, as well as other open data providers can provide information about prices, volatility and liquidity for a given crypto asset (as well as other information), so it is possible to do this calculation on-the-fly for a given user at a given time for a given crypto asset.

### Historical Data and Predictive Algorithms

To further empower users of the system and platform of the present invention, NVC will also provide historical data on fees and rates, as well as predictive algorithms that can help to forecast the best possible time to make a transaction. This predictive feature is preferably carried out with the help of machine learning algorithms, for example, which will make use of historical data to get trained to identify patterns that will maximize users' return. One can argue this can be modeled as an optimization problem, where the goal is to maximize a user's return considering trading and withdrawal fees. Such parameters could also be a function of other dynamic parameters, such as the given crypto asset current liquidity, the state of the market (bullish or bearish), the average trading volume associated with the current user, current market volatility, and price trends, just to mention a few, as well as more static parameters like the currency and country (which tend to be static for a given user). All the mentioned parameters will be mixed in a machine learning model, which will be trained with the given historical data. During this training, the model should adjust its parameters to minimize the cost function defined earlier.

After training, it is important to have the model validated with old and new test data, to make sure the results are in accordance with the expected returns.

Once the model implementation is ready and integrated into NVC, users can set alerts to notify them when their desired conditions are met, such as a drop in transaction fees or a favorable exchange rate, thereby maximizing the value of their withdrawals. Furthermore, the user can choose to let NVC complete the conversion and off-ramp, if and when a pre-defined condition is met. This feature represents a significant step towards making cryptocurrency transactions as user-friendly and cost-effective as possible.

### Intuitive User Interface for Cost Analysis

The user interface for this feature is designed with clarity and ease of use in mind. Upon initiating a transaction, the user is presented with a comparison chart or list that displays the current transaction fees and exchange rates from multiple exchanges.

The system automatically calculates and suggests the most cost-efficient option, taking into consideration all the given parameters, like the total amount the user wishes to off-ramp, the target currency and country, the current trading and off-ramping fees and the market conditions.

As it relates to cryptocurrency, it should be noted that the platform and system of the present invention is preferably disposed in communication with multiple cryptocurrency exchanges, and therefore has access to ledger feeds for multiple exchanges. This provides users the option, preferably via a radio button, to select the “best price” of the available exchanges based on present (current) values of gas fees, transaction fees per the exchange, conversion fees, and other known fees where applicable. Alternately, users may opt to manually select a desired exchange from a drop-down menu or similar selection mechanism. Further, the system of the present invention has the capability to set up a user's own exchange wallet.

However, if users prefer, they can use an escrow company to have their crypto wallets in their system to facilitate conversions to fiat currency. These options are also preferably available to users via radio buttons or similar selection mechanisms.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

We claim:

1. A unified resource transaction system and framework to facilitate transactions between users (user-to-user) and external parties (user-to-external party) comprising:
at least one server computer, said at least one server computer hosting an account management environment to a network which is accessible to users; and
wherein the account management environment is disposed in communication with sources of the users, facilitating transactional access to resources of said sources of the users.

2. The system and framework of claim 1, wherein sources are financial accounts.

3. The system and framework of claim 1, wherein sources are cryptocurrency wallets.

4. A method of enacting secured resource transactions between users and between users and external parties, the method comprising:
connecting at least one server computer to a network;
the at least one server computer hosting an account management environment which is accessible to users of the account management environment;
the account management environment prompting users to create a nick;
wherein a nick is a unique user identifier;
users each selecting at least one nick via the account management environment;
the account management environment storing the nicks in a database in communication with the at least one server computer;
the account management environment verifying the selected nick(s) of each user via at least one authentication scheme;
the account management environment assigning a UID to each user which is immutable;
the account management environment prompting the user(s) to provide information pertaining to sources of their resources;
the user(s) disclosing the location and type of their source(s), each containing resources; and
the account management environment assigning each disclosed source of the user to their verified nick.

5. The method of claim 4, further comprising:
a first user desiring to convey resources from at least one source to a second user;
the first user querying the database to find and confirm the identity of the second user by searching for at least one known nick of the second user;
wherein a nick is a verified nickname of a user that proves user control of resources at at least one source;
the database returning results of the query and displaying them within the account management environment;
the first user selecting the nick of the second user, instructing the account management environment to initiate a new session between the first user and the second user;
the account management environment initiating a new session, establishing communication between the first user and the second user in which a terminal conveys requests to both the first user and second user when a response is needed;
the first user selecting the source from which the first user wishes to convey resources to the second user;
the first user selecting a destination for the resources from a list of sources assigned to the nick of the second user;
the account management environment providing the second user the option to change the destination for the resources to a different source;
if the resources are cryptoassets, the account management environment providing the first user the option to automatically determine the least expensive exchange through which the transaction may occur and positing the least expensive exchange as the preferred option; and
the account management environment facilitating the transaction of resources via the selected exchange mechanism.

5. The method of claim 4, wherein the nick is at least one of the following: an email address, a phone number, a social security number, a tax ID number, a passport number, SSL certificate, registration number of a corporate entity, a user ID, an ad-hoc email, and biometric data.

6. The method of claim 5, wherein sources are financial accounts.

7. The method of claim 5, wherein sources are cryptocurrency wallets.
